(19) United States
(12) Patent Application Publication
(10) Pub. No.: US 2023/0267511 A1
(43) Pub. Date: Aug. 24, 2023

(54) MOBILE SALES DEVICE

(71) Applicant: Toshiba Tec Kabushiki Kaisha, Tokyo (JP)

(72) Inventors: Kento KAWATA, Fujisawa Kanagawa (JP); Takahide MATSUMOTO, Higashimurayama Tokyo (JP); Morito NATSUME, Koto Tokyo (JP); Mikio ITO, Ota Tokyo (JP); Taro ANDO, Izunokuni Shizuoka (JP); Ai HIRAI, Koto Tokyo (JP); Kizuku INOUE, Yokohama Kanagawa (JP); Tsuyoshi NAKAI, Nara Nara (JP)

(21) Appl. No.: 18/157,178

(22) Filed: Jan. 20, 2023

(30) Foreign Application Priority Data
Feb. 22, 2022 (JP) 2022-025338

(51) Int. Cl. G06Q 30/02; G06Q 30/0241; G06Q 20/18; B25J 11/00

(52) U.S. Cl. CPC G06Q 30/0281; G06Q 30/0241; G06Q 20/18; B25J 11/0015

(57) ABSTRACT

According to one embodiment, a mobile sales device includes an accommodation unit to hold commodities to be purchased by a user, an operation display unit to display information to the user when purchasing a commodity held in the accommodation unit and to receive an input operation performed by the user during the purchasing of the commodity, and a commodity information display unit. The commodity information display unit is configured to display information about the commodities in the accommodation unit. A display controller is provided to cause at least one of the operation display unit and the commodity information display unit to display an advertisement during movement of the mobile sales device.

### CROSS-REFERENCE TO RELATED APPLICATION

This application is based upon and claims the benefit of priority from Japanese Patent Application No. 2022-025338, filed Feb. 22, 2022, the entire contents of which are incorporated herein by reference.

### FIELD

Embodiments described herein relate to a mobile sales device.

### BACKGROUND

There has been proposed a system including a mobile robot that moves within a retail store and supports shopping of a customer in the store. The robot travels within the store and carries an item to be purchased for the customer around the store and then to a register for checkout or the like.

As described, such a system only assists the customer while shopping inside the store. A more useful system for a business operator who sells merchandise would be desirable.

### BRIEF DESCRIPTION OF THE DRAWINGS

FIG. 1 is a diagram illustrating an example of a configuration of a mobile sales system according to a first embodiment.

FIGS. 2 to 4 are perspective views illustrating an example of a mobile sales device.

FIGS. 5A and 5B depict accommodating units illustrating examples of shelf labels.

FIG. 6 is a diagram illustrating an example of a hardware configuration of a mobile sales device.

FIG. 7 is a block diagram illustrating functional aspects of a mobile sales device.

FIG. 8 is a perspective view illustrating an example of a mobile sales device according to a second embodiment.

FIG. 9 depicts aspects of a mobile sales device in a particular mode.

FIG. 10 depicts aspects of a mobile sales device in another mode.

### DETAILED DESCRIPTION

According to one embodiment, a mobile sales device includes an accommodation unit configured to hold commodities to be purchased by a user, an operation display unit configured to display information to the user when purchasing a commodity held in the accommodation unit and receive an input operation performed by the user during for the purchasing of the commodity, a commodity information display unit configured to display information about the commodities held in the accommodation unit, and a display controller configured to cause at least one of the operation display unit and the commodity information display unit to display an advertisement during movement of the mobile sales device.

Hereinafter, certain example embodiments will be described with reference to drawings. The present disclosure is not limited to these particular examples.

### First Embodiment

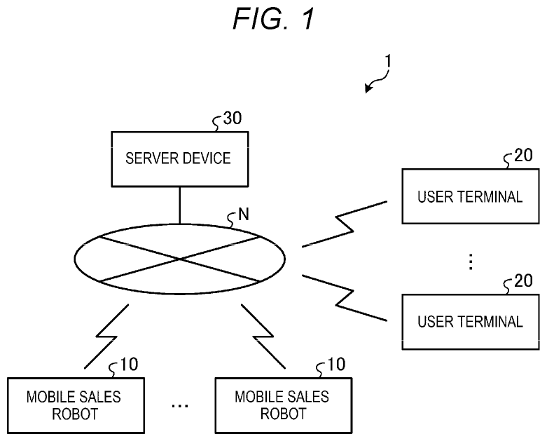

FIG. 1 is a diagram of a mobile sales system according to an embodiment. As illustrated in FIG. 1, the mobile sales system 1 includes mobile sales robots 10, user terminals 20, and a server device 30. The mobile sales robots 10, the user terminals 20, and the server device 30 are connected to a network N such as a local area network (LAN).

Each mobile sales robot 10 is a self-propelled device which transports and sells items of merchandise in an automated manner. A mobile sales robot is one example of a mobile sales device. For example, the mobile sales robot 10 travels within a predetermined range or area, such as a shopping mall or the like. The mobile sales robot is capable of selling items at any location within the predetermined range/area or in response to customer calls (requests) for service at a particular traveling destination. The mobile sales robot 10 performs patrol traveling of traveling along a predetermined route (circuit travel) and/or call (on-demand) traveling to a position designated by a customer. The number of the mobile sales robots 10 is not limited.

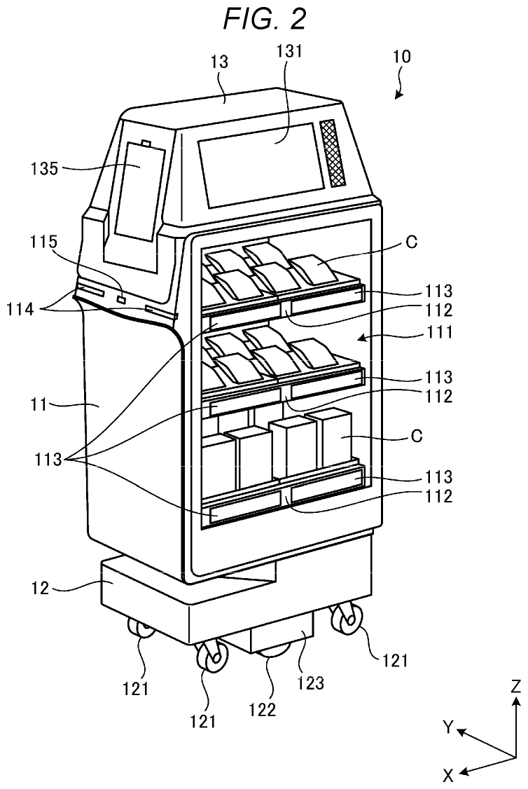

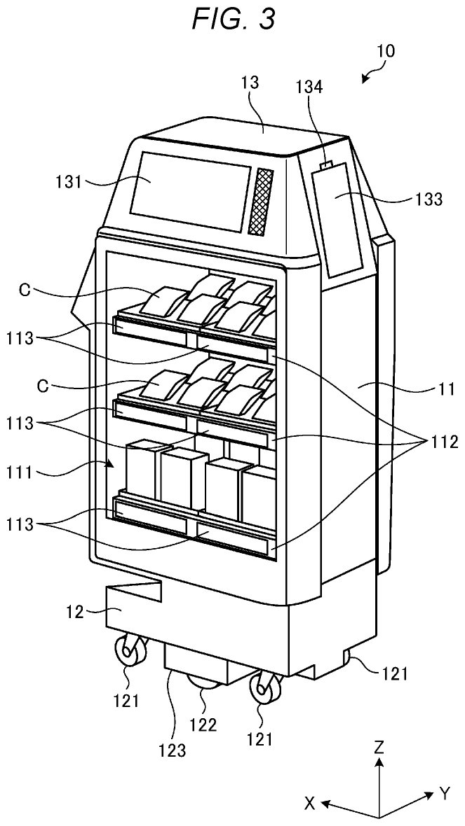

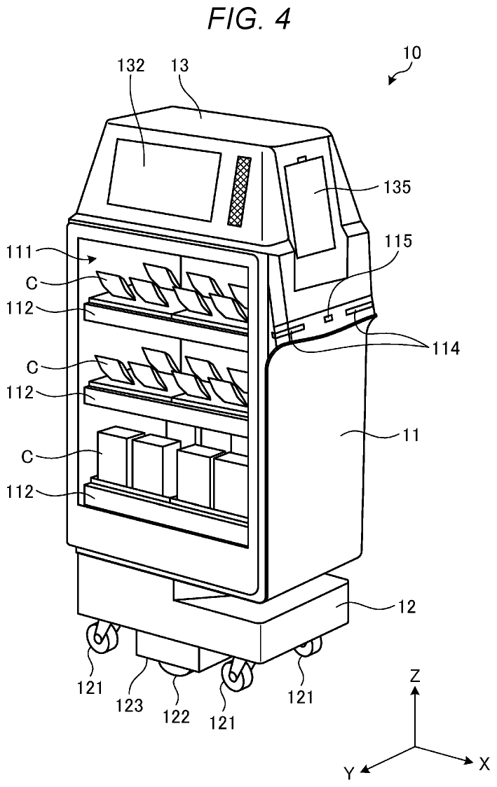

The outward appearance and other aspects of a mobile sales robot 10 according to the first embodiment will be described with reference to FIGS. 2 to 4. FIGS. 2 to 4 are perspective views illustrating examples of the appearance of a mobile sales robot 10.

In FIGS. 2 to 4, the configurations of the mobile sales robot 10 will be described using three axial directions of an X axis, a Y axis, and a Z axis which are orthogonal to each other.

The mobile sales robot 10 includes a main unit 11, a moving unit 12, and a user interface unit 13. The main unit 11 provides a box-shaped region that is open on a front surface side and a back surface side. An accommodating unit 111 (merchandise storing unit) is provided inside the main unit 11.

The accommodating unit 111 is a space for commodities C to be sold, such as food to be stored before purchase. In the accommodating unit 111, shelves 112 on which the commodities C can be displayed are arranged in a plurality of stages in the mobile sales robot 10. The shelf 112 is an example of a display unit that displays the commodity. The commodities C are placed on the shelves 112 by a store clerk or the like who manages the mobile sales robot 10. The commodities C in the accommodating unit 111 are not limited to food, and may be commodities of other types such as medicines or leisure articles. The accommodating unit 111 may accommodate the commodities C of a plurality of types.

For example, the shelf 112 may be divided into a plurality of regions so items may divided into different regions by class or type. The shelf 112 may be divided into a plurality of regions by using a tray or the like.

In the present example, items are displayed in the accommodating unit 111 assuming that the customer will see the items from the left side of the mobile sales robot 10 (a negative side of the Y axis). Therefore, in the following description, the left side of the mobile sales robot 10 is also referred to as a front surface side of the accommodating unit 111. The right side (a positive side of the Y axis) of the mobile sales robot 10 is also referred to as a back surface side of the accommodating unit 111.

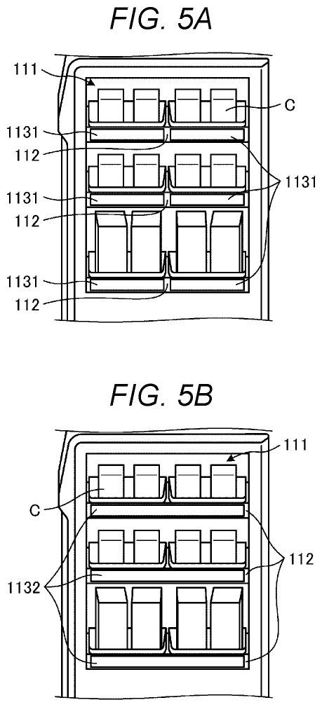

FIGS. 5A and 5B are front views of the accommodating units illustrating examples of shelf labels 113. The shelf label 113 displays a name and/or a price of the commodity C and is provided on a front surface side of the shelf 112.

In the first embodiment, particular examples of the shelf label 113 include shelf labels 1131 illustrated in FIG. 5A and shelf labels 1132 illustrated in FIG. 5B. The shelf label 1131 illustrated in FIG. 5A is a display device also called an electronic shelf label, and is implemented by an electronic paper or the like. The shelf label 1132 illustrated in FIG. 5B is a horizontally long display device also called a bar type display, and is implemented by a liquid crystal panel or the like.

The shelf labels 113 according to the first embodiment are an example of a commodity information display unit, and display information about an item being displayed in association therewith (e.g., commodity information such as price, commodity name, or the like) in a rewritable (updateable) manner. The shelf label(s) 113 can also function as a digital signage that displays information serving as an advertisement to a customer or potential customer. In the first embodiment, the shelf label 113 displays the advertisement during movement of the mobile sales robot 10, and then displays commodity information while the mobile sales robot 10 is stopped.

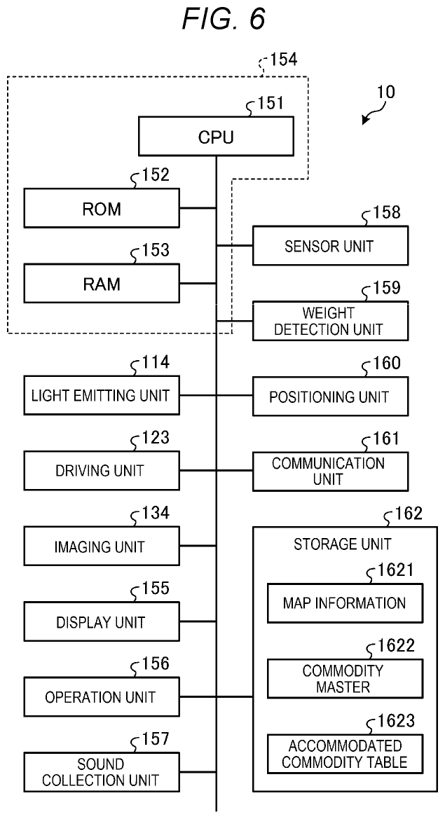

Each shelf 112 is provided with a weight detection unit 159 (see FIG. 6) that can detect a weight of the commodity C placed on the shelf 112. The weight detection unit 159 detects when a commodity previously placed on the shelf 112 is removed from the shelf 112 or when a commodity is returned to the shelf 112 after removal.

In the first embodiment, a shelf label 113 is provided on the front surface side of each shelf 112, but a shelf label 113 may also or instead be provided on a back surface side of a shelf 112. Furthermore, both the front surface side and the back surface side of the main unit 11 (accommodating unit 111) are open in the present embodiment but in other examples just one side (for example, the front surface side) may be open.

A door portion formed of a light transmissive member such as a glass may be attached to one or both of the front surface side and the back surface side of the main unit 11 (accommodating unit 111), and the inside of the accommodating unit 111 may be accessed via opening of the door portion. In some examples, a door portion may be attached to the front surface side of the main unit 11, but the back surface side of the main unit 11 may be covered with a fixed, wall surface. In this case, the wall surface on the back surface side may be formed using the light transmissive member such as the glass. The door portions and/or wall surfaces are provided to prevent the merchandise in the accommodating unit 111 from falling out of the accommodating unit 111 during the movement of the mobile sales robot 10 or the like.

Additionally, the door portion may be locked by providing an electronic lock or the like which can prevent items from being illegally removed during movement of the mobile sales robot 10 or the like.

Light emitting units 114 and a distance measuring sensor 115 are provided on a front side of the main unit 11. The light emitting unit 114 includes a light emitting element such as a light emitting diode (LED), and notifies an operation state of the mobile sales robot 10 by emitting light in accordance with control of a control unit 154. For example, the light emitting unit 114 notifies that the mobile sales robot 10 is presently moving by emitting a particular light during the movement of the mobile sales robot 10.

An emission color of the light emitting unit 114 is not limited to a single color. For example, the light emitting unit 114 may change the emission color or a light emitting pattern in accordance with the operation state of the mobile sales robot 10. The light emitting unit 114 may be provided not only on the front side but also on a rear side of the main unit 11.

The distance measuring sensor 115 is a sensor device that detects an object around the mobile sales robot 10 and a distance to the object. A sensing result of the distance measuring sensor 115 is output to the control unit 154 and is used for collision avoidance during movement, detection of a user, and the like. The distance measuring sensor 115 can be implemented by, for example, a sensor device that detects objects or measures distances by capturing images or by use of an ultrasonic wave, or a sensor device such as a light detection and ranging (LiDAR) that detects the object by laser light.

The position where the distance measuring sensor 115 is provided is not limited to the front side of the mobile sales robot 10. For example, the distance measuring sensor 115 may be provided at another position such as the rear side of the mobile sales robot 10. An imaging unit 134 to may be used as the distance measuring sensor 115.

The moving unit 12 is provided on a lower side of the main unit 11 and movably supports the main unit 11. Specifically, the moving unit 12 includes non-driving wheels 121, a driving wheel 122, and a driving unit 123 that drives the driving wheel 122.

The non-driving wheel 121 is a small wheel. The non-driving wheel 121 changes a traveling direction of the mobile sales robot 10 (moving unit 12) by freely changing an orientation of the non-driving wheel 121 in accordance with an orientation of a force generated by rotation of the driving wheel 122.

The driving wheel 122 is rotationally driven by the driving unit 123 to move the mobile sales robot 10 (moving unit 12) forward or backward or turn around.

The driving unit 123 includes a driving source such as a motor or a power supply. The driving unit 123 rotationally drives the driving wheel 122 in accordance with the control from the control unit 154, thereby moving the mobile sales robot 10 in a direction and to a position instructed by the control unit 154.

The user interface unit 13 is provided on an upper portion of the main unit 11. In this example, the user interface unit 13 includes a first display unit 131, a second display unit 132, a third display unit 133, the imaging unit 134, and a fourth display unit 135.

The first display unit 131 is a display device installed on the front surface side of the accommodating unit 111. The second display unit 132 is a display device installed on the back surface side of the accommodating unit 111. The third display unit 133 is a display device installed on a rear side of the mobile sales robot 10. The fourth display unit 135 is a display device installed on a front side of the mobile sales robot 10. The first display unit 131, the second display unit 132, the third display unit 133, and the fourth display unit 135 display various types of information related to sales of a commodity C and the like in accordance with the control of the control unit 154.

The imaging unit 134 is installed on the rear side of the mobile sales robot 10. The imaging unit 134 is a digital camera including an imaging element such as a charge coupled device (CCD) or a complementary MOS (CMOS). The imaging unit 134 captures an image of a user (customer) who uses the mobile sales robot 10 to acquire a face image (facial image) or the like of the user.

A configuration of the user interface unit 13 is not limited to the illustrated example. For example, the number of display devices and installation positions are not limited to the illustrated example. The user interface unit 13 may also include a reader device that reads information from a code symbol such as a two-dimensional code (e.g., a barcode or the like), a reader device that reads information from a card medium such as an IC (integrated circuit) card or a credit card, and the like.

Referring back to FIG. 1, the user terminal 20 is used by a user of the mobile sales system 1 and is an example of a terminal device. The user terminal 20 is implemented as a portable terminal device such as a smartphone or a tablet terminal. The user terminal 20 outputs a call request to the server device 30 for requesting a mobile sales robot 10 to come to a user position. The number of the user terminals 20 is not limited.

The server device 30 manages the mobile sales system 1. The server device 30 is implemented as, for example, an information processing device such as a personal computer (PC). The server device 30 tracks the commodities (items) sold by each mobile sales robot 10. The server device 30 manages the mobile sales robot 10 and causes the mobile sales robot 10 to travel toward a call position designated by a call request received from a user terminal 20. For example, the server device 30 tracks current positions of the mobile sales robots 10 and the user terminals 20, and causes a mobile sales robot 10 designated by the call request to travel toward the position of the user terminal 20 after receiving a call request for the mobile sales robot 10 from the user terminal 20.

A hardware configuration and functional aspects of components provided in the mobile sales system 1 will be described.

FIG. 6 is a diagram illustrating an example of the hardware configuration of the mobile sales robot 10. As illustrated in FIG. 6, the mobile sales robot 10 includes a central processing unit (CPU) 151, a read only memory (ROM) 152, a random access memory (RAM) 153, and a storage unit 162.

The CPU 151 is an example of a processor, and integrally controls each unit of the mobile sales robot 10. The ROM 152 stores various programs. The RAM 153 provides a workspace for loading the programs and various types of data.

The storage unit 162 can be a storage medium such as a hard disk drive (HDD) or a flash memory, and maintains a stored content even when the power supply is cut off. The storage unit 162 stores programs and various types of setting information that can be executed by the CPU 151.

The CPU 151, the ROM 152, and the RAM 153 are connected via a bus or the like, and constitute the control unit 154. In the control unit 154, the CPU 151 operates in accordance with a program stored in the ROM 152 or the storage unit 162 and loaded in the RAM 153, thereby executing various processes.

The mobile sales robot 10 further includes the light emitting unit 114, the driving unit 123, and the imaging unit 134. The mobile sales robot 10 further includes a display unit 155, an operation unit 156, a sound collection unit 157, a sensor unit 158, weight detection units 159, a positioning unit 160, a communication unit 161, and the like.

The display unit 155 is a display device such as the first display unit 131, the second display unit 132, the third display unit 133, the fourth display unit 135, and/or the shelf labels 113. The display unit 155 is implemented by a liquid crystal display (LCD) or the like. The display unit 155 displays various types of information under control of the CPU 151.

The operation unit 156 is input device and outputs user inputs received from the user to the CPU 151. The operation unit 156 can be a touch panel superposed on a display screen of the display unit 155 other than the shelf labels 113. In the present example, the first display unit 131, the second display unit 132, the third display unit 133, and the fourth display unit 135 provided with a touch panel serving as an operation unit 156.

The sound collection unit 157 collects sound around the mobile sales robot 10, and outputs a sound signal of the collected sound to the CPU 151. The sound collection unit 157 can be a device such as a microphone. The sound collection unit 157 collects, for example, a voice command/request for causing the mobile sales robot 10 to stop traveling from a user who wants to purchase a commodity during the patrol traveling from the mobile sales robot 10.

The sensor unit 158 is a sensor device such as the distance measuring sensor 115. The sensor unit 158 outputs a detection result obtained by sensing to the CPU 151.

The weight detection unit 159 is a weight sensor that detects a weight of the commodities accommodated in the accommodating unit 111. Specifically, the weight detection unit 159 is provided on each shelf 112, and detects the weight and the weight change of the commodities placed on the shelf 112.

In this example, a weight detection unit 159 is provided corresponding for each shelf 112, and when a weight change is detected by a weight detection unit 159, the shelf 112 having the change can be identified.

When the shelf 112 is divided into a plurality of regions, a weight detection unit 159 may be provided for each divided region. In this case, the divided regions and the weight detecting units 159 provided for the regions are correlated.

The positioning unit 160 measures a current position of the mobile sales robot 10. The positioning unit 160 can be implemented by, for example, a positioning device using a positioning technique such as a global positioning system (GPS).

The positioning unit 160 may be implemented by a position measuring device using a positioning technique such as beacon positioning and radio frequency identifier (RFID) positioning. In this case, by providing a terminal corresponding to the positioning technique such as the beacon positioning and the RFID positioning at several positions within a travelling range of mobile sales robot 10, the current position of the mobile sales robot 10 can be measured (specified) by a positioning system including the terminals and the positioning unit 160.

The communication unit 161 is a wireless communication interface connectable to the network N. The communication unit 161 communicates with an external device such as the server device 30 via the network N.

The storage unit 162 stores map information 1621, a commodity master 1622, and an accommodated commodity table 1623. Here, the map information 1621 is information indicating a map of the range in which the mobile sales robot 10 moves.

The commodity master 1622 is a data table for storing information related to the commodity to be sold. The commodity master 1622 stores, in association with a commodity code for identifying a commodity, commodity information of the commodity corresponding to the commodity code. The commodity information includes the commodity name, a type, the price, the weight, image data, and the like. The commodity master 1622 may store image data representing a feature of the commodity in the commodity information.

In some examples, the storage unit 162 may not store the commodity master 1622. In this case, the mobile sales robot 10 can handle a commodity master similarly to a configuration of storing the commodity master 1622 by referring to a commodity master stored in the server device 30.

The accommodated commodity table 1623 is a data table for storing information related to items (merchandise) accommodated in the accommodating unit 111. The accommodated commodity table 1623 stores, in association with a shelf ID capable of identifying the shelf 112 provided in the accommodating unit 111, the commodity codes and the number of the commodities placed on the shelf 112 of the corresponding shelf ID. When the shelf 112 is divided into a plurality of regions, the accommodated commodity table 1623 may allocate an identifier for each divided region, and store the commodity codes and the number of the commodities placed in each of the regions.

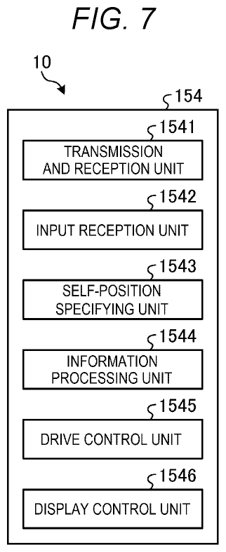

FIG. 7 is a block diagram illustrating an example of the functional aspects of the mobile sales robot 10.

The control unit 154 of the mobile sales robot 10 functions as a transmission and reception unit 1541, an input reception unit 1542, a self-position specifying unit 1543, an information processing unit 1544, a drive control unit 1545, and a display control unit 1546 (display controller) by the CPU 151 operating in accordance with a control program stored in the ROM 152 or the storage unit 162. In some examples, the described functions may be implemented by hardware such as a dedicated circuit.

The transmission and reception unit 1541 transmits and receives various types of information to and from an external device such as the server device 30 via the communication unit 161. For example, the transmission and reception unit 1541 transmits position information illustrating a position of the mobile sales robot 10 and state information illustrating a state of the mobile sales robot 10 to the server device 30 at any time.

The transmission and reception unit 1541 transmits an authentication request to the server device 30 and receives an authentication notification from the server device 30. The authentication request is for requesting authentication by a pin code input to the input reception unit 1542, and includes the pin code and a robot ID received by the input reception unit 1542. The transmission and reception unit 1541 transmits a settlement request to the server device 30 and receives a settlement completion notification from the server device 30. The settlement process is executed by the server device 30 in this example.

The input reception unit 1542 receives input information based on an operation of the operation unit 156 by a user. For example, the input reception unit 1542 receives a pin code and a settlement instruction input by an operation of the user.

The self-position specifying unit 1543 specifies the position of the mobile sales robot 10 in the map information 1621 based on an output of the positioning unit 160.

The information processing unit 1544 executes various processes based on various types of information input into the mobile sales robot 10.

For example, when the transmission and reception unit 1541 receives a movement instruction from the server device 30, the information processing unit 1544 determines a movement route to the call position based on the map information 1621.

When the weight detection unit 159 detects the weight change of a shelf 112, the information processing unit 1544 reads the commodity code(s) corresponding to the shelf ID of the shelf 112 having the weight change from the accommodated commodity table 1623, and identifies the commodity removed from the shelf 112 (or the commodity returned to the shelf 112).

For example, when the weight change is a decrease in weight, the information processing unit 1544 reads the commodity codes stored in association with the shelf ID of the shelf 112 having the weight change. Then, the information processing unit 1544 refers to the commodity master 1622 to specify a commodity code corresponding to the decreased weight among weights associated with the read commodity codes, thereby identifying a particular commodity taken from the shelf 112. In this case, the information processing unit 1544 reads commodity information corresponding to the specified commodity codes from the commodity master 1622 and registers the commodity information in the RAM 153 (hereinafter, also referred to as “commodity registration”). That is, the information processing unit 1544 also functions as a registration unit that executes a commodity registration operation. The information processing unit 1544 subtracts the number of items taken out from the shelf 112 from the number of the specified commodity codes stored in the accommodated commodity table 1623.

If the weight change is an increase in weight, the information processing unit 1544 reads the commodity codes stored in association with the shelf ID of the shelf 112 having the weight change. Then, the information processing unit 1544 refers to the commodity master 1622 to identify a commodity code corresponding to the increased weight among weights associated with the read commodity codes, thereby specifying which commodity has been returned to the shelf 112. In this case, the information processing unit 1544 deletes the commodity information corresponding to the specified commodity code from the RAM 153 (e.g., from the registered commodity list). The information processing unit 1544 increases the number of the commodities presently stored the shelf 112 in the accommodated commodity table 1623 to reflect the return of the item to the shelf 112.

In some examples, the registration of the commodity information may be executed by the server device 30. Specifically, the information processing unit 1544 transmits the commodity code of the commodity taken from the shelf 112 to the server device 30 via the transmission and reception unit 1541. Then, the server device 30 reads, from the commodity master stored in the server device 30, the commodity information corresponding to the received commodity code, and registers the commodity information. In this case, the information processing unit 1544 implements a function of causing the server device 30 to register the commodity information.

When the input reception unit 1542 receives the settlement instruction (request to complete the sales transaction), the information processing unit 1544 executes a payment process. The payment process is a process by which the user pays a purchase price of any removed items. In the present embodiment, the payment process includes calculation of the total purchase price for items for which the commodity registration was executed, acquisition of face image data of the purchasing customer, and transmission of the settlement request to the server device 30.

The server device 30 executes the settlement process when the settlement request is received from the mobile sales robot 10. In the present embodiment, the server device 30 executes an electronic settlement process based on face authentication. Specifically, the server device 30 executes settlement using settlement information associated with the user corresponding to the face image data. In the present example, the server device 30 executes the settlement process by communicating with a settlement server of a settlement processor companying (e.g., a credit card company or electronic payment service). The server device 30 may also or instead perform electronic settlement by credit card settlement or two-dimensional code settlement.

When the mobile sales robot 10 executes the settlement process rather than the server device 30, the payment process executed by the information processing unit 1544 includes the operations associated with settlement process described above. In some examples, the mobile sales robot 10 may include an automatic change machine or the like for handling cash settlement. In this case, the information processing unit 1544 controls the automatic change machine as appropriate.

The information processing unit 1544 executes sound recognition on the sound collected by the sound collection unit 157, and outputs a stop instruction to the drive control unit 1545 as necessary. For example, the information processing unit 1544 outputs a stop instruction to the drive control unit 1545 when a sound (voice command/request) for causing the mobile sales robot 10 to stop is recognized by sound recognition.

When the transmission and reception unit 1541 receives an authentication notification from the server device 30, the information processing unit 1544 permits processes related to the sale of merchandise and the like. That is, when the user who calls the mobile sales robot 10 and a user who intends to start shopping are matched with each other by the server device 30, the information processing unit 1544 permits the processes related to the sale of merchandise.

For example, the information processing unit 1544 cooperates with the display control unit 1546 to cause the display unit 155 to display an initial screen for starting the shopping. When the door portion for accessing the accommodating unit 111 is lockable, the information processing unit 1544 releases lock of the door portion, thereby permitting the customer to access the stored items of the mobile sales robot 10.

The drive control unit 1545 controls the driving unit 123 to cause the mobile sales robot 10 to travel or stop. The mobile sales robot 10 performs, under the control of the drive control unit 1545, patrol traveling of traveling along the predetermined route and call traveling toward the call position as designated by the customer.

The drive control unit 1545 causes the mobile sales robot 10 to move to service or restocking yard or the like when it is detected that commodities stored in the accommodating unit 111 are out of stock. When the mobile sales robot 10 travels in the shopping mall or the like, the drive control unit 1545 may cause the mobile sales robot 10 to move to a store that supplies a commodity that is presently out of stock on the mobile sales robot 10.

The display control unit 1546 controls the first display unit 131, the second display unit 132, the third display unit 133, the fourth display unit 135, and the shelf labels 113, and causes these displays (also referred to as display unit 155) to display various types of information. The display control unit 1546 changes displayed content depending on whether the mobile sales robot 10 is moving or stopped (that is, while providing customer service).

For example, if the mobile sales robot 10 is stopped, the display control unit 1546 causes the shelf label 113 (1131 and 1132) to display the commodity information including the price of the items displayed on the shelves 112. While the mobile sales robot 10 is stopped, the display control unit 1546 causes the first display unit 131 to display information related to the commodity taken out from the accommodating unit 111, and causes the third display unit 133 to display information related to the settlement of the commodity, such as information for guiding a settlement method of the commodity.

At this time, while the mobile sales robot 10 is stopped, the display control unit 1546 causes the second display unit 132 and the fourth display unit 135 to display, for example, information related to sales promotion (an advertisement) for a commodity, such as information for advertising a particular commodity accommodated in the accommodating unit 111.

If the mobile sales robot 10 is moving, the display control unit 1546 causes at least one of the first display unit 131, the second display unit 132, the third display unit 133, the fourth display unit 135, and the shelf labels 113 to display an advertisement.

A display unit such as the first display unit 131 used for the commodity registration or operation and the shelf labels 113 illustrating the commodity information during a stop for customer service and merchandise sales can be diverted to display an advertisement during movement. Therefore, a mobile sales device can be provided that can more effectively use various equipped devices during movement when a merchandise sale cannot be performed.

Described example embodiments may be modified in various aspects with respect to configuration and/or functions. In the following, certain modifications will be described.

### Modification

The mobile sales robot 10 according to one modification may further include or provide a decoration acquisition unit. That is, the control unit 154 may further function as a decoration acquisition unit. The decoration acquisition unit acquires image information as decorating information to be displayed under control of the display control unit 1546. The decorating information may be stored in (and acquired from) the storage unit 162 of the mobile sales robot 10 or the server device 30.

The relevant image information may be stored in association with, for example, a particular sales area, display date, time period, and day of the week or combinations thereof corresponding to time and/or place for display of the image information (decorating information). The decoration acquisition unit may acquire image information appropriate to a particular sales area, date, time, or the like by reference to such information as present position, date, time, or the like.

The display control unit 1546 causes the shelf label 113 to display the information acquired by the decoration acquisition unit together with the information on the commodity.

Thus, decorations suitable for the sales area, the date, the time zone, and the day of the week can be applied to the shelf labels 113. Accordingly, when the shelf label 113 displays information, a sense of seasons can be reflected, or a style can be applied that is considered to be preferred by a customer who is assumed to be in a particular sales area.

### Second Embodiment

Description of the second embodiment will focus on points different from those of the first embodiment and detailed description of points in common with the first embodiment (or modifications thereof) be omitted.

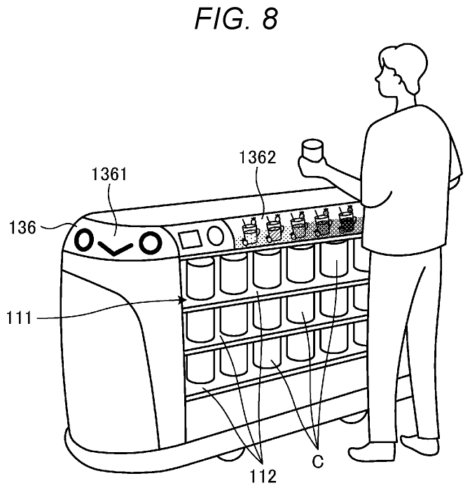

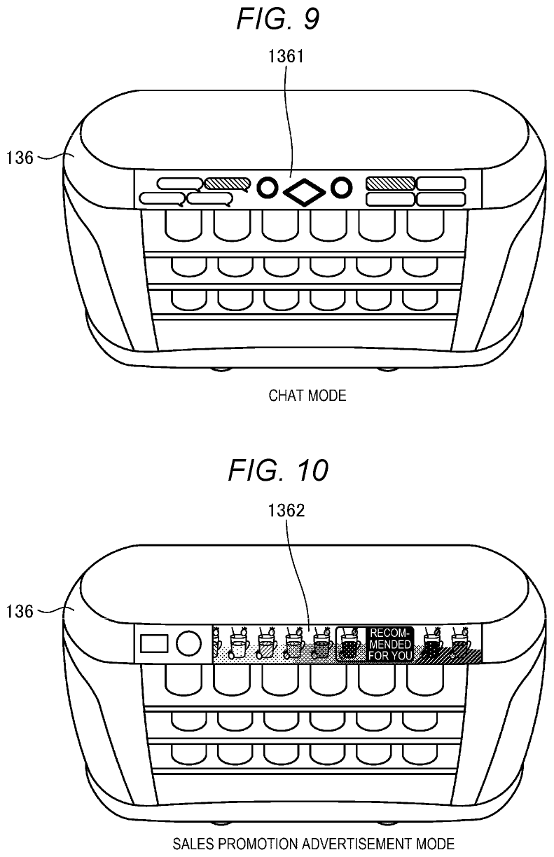

FIG. 8 is a perspective view illustrating an example of an appearance of the mobile sales robot 10 of a second embodiment during movement. FIGS. 9 and 10 are examples of appearances of a mobile sales robot 10 during a stop (during customer service, during sales). FIG. 9 illustrates a state in which the mobile sales robot 10 is operating in a chat mode. FIG. 10 illustrates a state in which the mobile sales robot 10 is operating in a sales promotion advertisement mode.

An operation display unit 136 according to the second embodiment is continuously provided around an upper portion of the mobile sales robot 10. That is, the operation display unit 136 encircles an upper portion of the mobile sales robot 10 in a continuous manner. The operation display unit 136 can displays information in a plurality of directions. A touch panel (operation unit 156) can be superposed on a surface of the operation display unit 136. The operation display unit 136 receives input from a user via the operation unit 156, and outputs the received operation content to the control unit 154.

In some examples, the operation display unit 136 only needs to be able to display information in multiple directions of the mobile sales robot 10, and need not be continuous around all portions of the mobile sales robot 10. In some examples, the operation display unit 136 may comprise the first display unit 131, the second display unit 132, the third display unit 133, and the fourth display unit 135 which were described for the first embodiment.

The display control unit 1546 according to the second embodiment functions as a so-called face display control unit. The face display control unit causes the operation display unit 136 to display an image or a symbol 1361 imitating a face facing frontwards in the traveling direction of the mobile sales robot 10 during movement of the mobile sales robot 10 (see FIG. 8). The display control unit 1546 then displays an image (or symbol 1361) imitating a face on the side of the mobile sales robot 10 corresponding to the display direction of items displayed on the accommodating unit 111 during a stop of the mobile sales robot 10 (see FIG. 9, chat mode).

During the operations of the chat mode, the mobile sales robot 10 may suggest an item by sound output or displayed images. During chat mode the shape of a portion of symbol 1361 corresponding to a mouth in can be changed to mimic the mouth movements of a person speaking, thereby facilitating communication with the user.

The face display control unit causes the symbol 1361 to move from an original display position to another display position when based on movement instructions for the mobile sales robot 10. Accordingly, it is possible to notify people around the mobile sales robot 10 when the mobile sales robot 10 will be moving and the direction of forward for the mobile sales robot 10.

The display control unit 1546 according to the second embodiment causes the front surface side and the back surface side of the accommodating unit 111 of the mobile sales robot 10 to display text, images, or the like serving as an advertisement 1362 (see FIG. 10) when in the sales promotion advertisement mode. The image or the symbol 1361 imitating the face may be displayed in the front of the traveling direction of the operation display unit 136 during movement and also during the operation in the sales promotion advertisement mode.

As described above, according to the second embodiment, the traveling direction can be indicated, communication with customers is facilitated, and sales can be promoted by advertisement.

While certain example embodiments are explained above, the present disclosure is not limited to these examples. The inventive aspects of the present disclosure can be embodied in various other forms. Various omissions, substitutions, and changes can be made without departing from the gist of the present disclosure. The described embodiments and the modifications thereof are included in the scope and gist of the present disclosure as provided in the accompanying claims and equivalents thereto.

What is claimed is:

1. A mobile sales device, comprising:
an accommodation unit configured to hold commodities to be purchased by a user;
an operation display unit configured to display information to the user when purchasing a commodity held in the accommodation unit and receive an input operation performed by the user during for the purchasing of the commodity;
a commodity information display unit configured to display information about the commodities held in the accommodation unit; and
a display controller configured to cause at least one of the operation display unit and the commodity information display unit to display an advertisement during movement of the mobile sales device.

2. The mobile sales device according to claim 1, wherein the display controller causes the operation display unit to display the advertisement during the movement of the mobile sales device.

3. The mobile sales device according to claim 1, wherein the display controller causes the commodity information display unit to display the advertisement during the movement of the mobile sales device.

4. The mobile sales device according to claim 1, wherein the display controller causes both the operation display unit and the commodity information display unit to display the advertisement during the movement of the mobile sales device.

5. The mobile sales device according to claim 1, wherein the display controller causes the commodity information unit to display the information about the commodities held in the accommodation when the mobile sales device is stopped to permit purchasing of the commodities held in the accommodating unit.

6. The mobile sales device according to claim 1, wherein the commodity information display unit comprises a plurality of electronic shelf labels adjacent to shelves in the accommodation unit.

7. The mobile sales device according to claim 1, wherein the operation display unit comprises an LCD screen.

8. The mobile sales device according to claim 1, wherein
the display controller is configured to acquire decorating image information from a storage unit, the decorating image information to be displayed on the commodity information display unit under control of the display controller, the decorating image information being stored in the storage unit in association with at least one of a sales location, a date, a time, or a day of the week, and
the display controller causes the commodity information display unit to display the decorating image information along with the information about the commodities.

9. The mobile sales device according to claim 1, wherein the operation display unit wraps around the mobile sales device and displays information in multiple directions.

10. The mobile sales device according to claim 9, wherein the display controller is further configured to:
cause the operation display unit to display an image representing a face in a traveling direction of the mobile sales device during movement, and
cause the operation display unit to display the image representing the face to display in a different direction while the mobile sales device is stopped.

11. A mobile sales robot, comprising:
an accommodation unit configured to hold commodities to be purchased by a user;
an operation display panel configured to display information to the user when purchasing a commodity held in the accommodation unit and receive an input operation performed by the user during for the purchasing of the commodity;
a plurality of electronic shelf labels configured to display information about the commodities held in the accommodation unit; and
a display controller configured to cause at least one of the operation display panel and the plurality of electronic shelf labels to display an advertisement during movement of the mobile sales device.

12. The mobile sales robot according to claim 11, wherein the display controller causes the operation display panel to display the advertisement during the movement of the mobile sales device.

13. The mobile sales robot according to claim 11, wherein the display controller causes the plurality of electronic shelf labels to display the advertisement during the movement of the mobile sales device.

14. The mobile sales robot according to claim 11, wherein the display controller causes both the operation display panel and the plurality of electronic shelf labels to display the advertisement during the movement of the mobile sales device.

15. The mobile sales robot according to claim 11, wherein the display controller causes the plurality of electronic shelf labels to display the information about the commodities held in the accommodation when the mobile sales device is stopped to permit purchasing of the commodities held in the accommodating unit.

16. The mobile sales robot according to claim 11, wherein the plurality of electronic shelf labels comprise electronic paper.

17. The mobile sales robot according to claim 11, wherein
the display controller is configured to acquire decorating image information from a storage unit, the decorating image information to be displayed on the plurality of electronic shelf labels under control of the display controller, the decorating image information being stored in the storage unit in association with at least one of a sales location, a date, a time, or a day of the week, and
the display controller causes the plurality of electronic shelf labels to display the decorating image information along with the information about the commodities.

18. The mobile sales robot according to claim 11, wherein the operation display panel wraps around the mobile sales device and displays information in multiple directions.

19. The mobile sales robot according to claim 18, wherein the display controller is further configured to:
cause the operation display panel to display an image representing a face in a traveling direction of the mobile sales device during movement, and
cause the operation display panel to display the image representing the face to display in a different direction while the mobile sales device is stopped.

20. The mobile sales robot according to claim 11, wherein the operation display panel is an LCD panel.
